(19) United States
(12) Patent Application Publication
(10) Pub. No.: US 2026/0189451 A1
(43) Pub. Date: Jul. 2, 2026

(54) MANAGING SYSTEM SERVICES BASED ON DETECTION OF MAINTENANCE EVENTS

(71) Applicant: Dell Products L.P., Round Rock, TX (US)

(72) Inventors: Apu Mandal, Plymouth, MN (US); Justine Rey Akehurst, Shelton, WA (US); Jason D. Thompson, Elk River, MN (US); Peter Kilner, Boulder, CO (US); Tim Haralson, Maple Valley, WA (US); Britney Carrier, Marysville, WA (US); Jack Eby, Burien, WA (US)

(21) Appl. No.: 19/006,988

(22) Filed: Dec. 31, 2024

(51) Int. Cl. H04L 41/06; H04L 67/10

(52) U.S. Cl. CPC H04L 41/06; H04L 67/10

(57) ABSTRACT

The technologies described herein are generally directed toward managing system services based on node maintenance events. For instance, a system can identify a maintenance event that implicates a node of a cluster of nodes. The system can further notify a service that the node is to be in a maintenance mode based on the maintenance event, with the node being at least partially not operative in the maintenance mode, and with the service subscribing to the maintenance event. The system can further, based on a completion event that implicates the node with respect to the maintenance event, switch the node from the maintenance mode to an operational mode in which the node is operative.

### BACKGROUND

Modern approaches to maintaining complex collections of computer systems may require coordination of dependencies among different systems. Different services provided by a system may depend on different nodes that are subject to periods of unavailability due to maintenance operations. Difficulties in managing the maintenance of complex systems may be aggravated by the combination of scheduled and unscheduled maintenance activities that may involve multiple different kinds of software and firmware updates.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example method may include identifying a maintenance event that implicates a node of a cluster of nodes. The example method may further include notifying a service that the node is to be in a maintenance mode based on the maintenance event, with the node being at least partially not operative in the maintenance mode, and with the service subscribing to the maintenance event. The example method may further include, based on a completion event that implicates the node with respect to the maintenance event, switching the node from the maintenance mode to an operational mode in which the node is operative.

In additional or alternative embodiments, the method may further include notifying the service that the node is in the operational mode. In additional or alternative embodiments, the maintenance event may include an event indicating that the node is to be in the maintenance mode. In additional or alternative embodiments, the maintenance event may include an event indicating that the node has already entered the maintenance mode. In additional or alternative embodiments, the completion event may be identified based on the maintenance event and the node. In additional or alternative embodiments, the method may further include, during the maintenance mode, delaying, by the system, delivery of the system alert to the service until the operational mode of the node is restored. In additional or alternative embodiments, the method may further include monitoring, by the system, system events generated by operation of the cluster of nodes, analyzing, by the system, the system events, based on the analyzing, determining, by the system, that a system event of the system events may include a maintenance event, and in response to the determining that the system event may include the maintenance event, switching, by the system, the node to the maintenance mode from the operational mode.

In additional or alternative embodiments, the system event may include at least one of a reboot event, a shutdown event, a node removal event, an upgrade event, or a hardware replacement event. In additional or alternative embodiments, the method may further include during the maintenance mode, monitoring, by the system, system events generated by operation of the cluster of nodes, analyzing, by the system, the system events, and based on the analyzing, determining, by the system, that a system event of the system events may include a completion event that implicates completion of the maintenance event, and the switching of the node to the operational mode switching the node to the operational mode in response to the determining that the system event may include the completion event that implicates completion of the maintenance event. In additional or alternative embodiments, the completion event may include a reversal of the maintenance event. In additional or alternative embodiments, the completion event may include a startup event.

An example system can operate as follows. At least one memory that stores computer executable components, and at least one processor may execute the computer executable components stored in the at least one memory. The computer executable components may include an event generator that may generate a system event that corresponds to a node of a cluster of nodes. The computer executable components may further include a receiver that may receive a first indication from a first monitor that the node has switched to a maintenance mode based on the system event. The computer executable components may further include a second monitor that may monitor event information corresponding to a second indication that the node has switched to an operational mode.

In additional or alternative embodiments, the computer executable components may further include a service provider that provides a service to the cluster, with the receiver receiving the first indication from the service provider based on the service being subscribed to communicate notifications from the first monitor. In additional or alternative embodiments, based on the service being subscribed to communicate the notifications, the second monitor monitors the second indication that the node has switched to the operational mode. In additional or alternative embodiments, the service provider further generates a message for the node based on the service, and wherein, based on the node being in the maintenance mode, communication of the message to the node can be delayed. In additional or alternative embodiments, the service provider further provides the message to the node based on the second indication.

An example non-transitory machine-readable medium may include executable instructions that, when executed by at least one processor, facilitate performance of operations. The operations may include identifying a maintenance event that relates to a node of a cluster of nodes. The operations may further include, based on the maintenance event, notifying a service that the node is to be in a maintenance mode in which operation of the node is at least partly disabled, with the service being subscribed to be notified of maintenance events relating to at least the node of the cluster of nodes. Further, the operations may include, based on a completion event that relates to the node, initiating a change in mode of the node from the maintenance mode to an operational mode in which the operation of the node may be enabled.

In additional or alternative embodiments, the operations may further include, based on the maintenance mode, suppressing delivery of alert messages from the service directed to the node, resulting in suppressed messages, and logging the suppressed messages. In additional or alternative embodiments, the operations may further include, based on the operational mode, enabling delivery of the suppressed messages to the node. In additional or alternative embodiments, the service comprises a cluster-wide event log.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 is an architecture diagram of an example system that can facilitate managing system services based on node maintenance events, in accordance with one or more embodiments;

FIG. 2 is an architecture diagram of an example system that can facilitate managing system services based on node maintenance events, in accordance with one or more embodiments;

FIG. 3 includes a diagram of an example system that can facilitate managing system services based on detection of node maintenance and completion events, in accordance with one or more embodiments;

FIG. 4 includes a diagram of an example system that can facilitate managing system services based on detection of node maintenance events, in accordance with one or more embodiments;

FIG. 5 includes a diagram of an example system that can facilitate managing system services based on detection of node maintenance events that may be specific to micro-clusters of activity, in accordance with one or more embodiments;

FIG. 6 depicts a flow diagram representing example operations of an example method that can facilitate managing system services based on detection of node maintenance events, in accordance with one or more embodiments;

FIG. 7 depicts an example system that can facilitate managing system services based on node maintenance events, in accordance with one or more embodiments;

FIG. 8 depicts an example non-transitory machine-readable medium that can include executable instructions that, when executed by a processor of a system, can facilitate managing system services based on node maintenance events, in accordance with one or more embodiments;

FIG. 9 is a schematic block diagram of a system with which the disclosed subject matter can interact; and

FIG. 10 illustrates an example block diagram of a computer operable to execute an embodiment of this disclosure.

### DETAILED DESCRIPTION

Various specific details of the disclosed embodiments are provided in the description below. One skilled in the relevant art(s) will recognize, however, that the techniques described herein can in some cases be practiced without one or more of the specific details, or with other methods, components, materials, etc. In other instances, well-known structures, materials, or operations are not shown or described in detail to avoid obscuring subject matter.

By utilizing one or more implementations as described herein, the performance, accuracy, efficiency, and specificity of a systems that plan, manage, and implement maintenance operations for nodes of a system can be improved, e.g., by providing approaches to detect unscheduled maintenance activity and automatically predict maintenance windows for scheduled maintenance activity, while preserving or improving the performance and efficiency of the ongoing maintenance process. One or more embodiments described herein provide solutions to problems associated with coordinating maintenance activities among large collections of interdependent computer systems. These problems become especially complex when services that depend upon one or more serviced nodes are sought to be prepared in advance for potentially overlapping maintenance windows. Further, it is noted that implementations described herein can provide solutions to technical problems that are inextricably tied to computer systems. For example, approaches are described that can coordinate deferral of programmatic messaging between computer systems during maintenance, detect and analyze large amounts of messaging between systems, and provide complex schedules for technical maintenance activity all solve technical problems with technical solutions. Moreover, implementations described herein can provide these solutions in a manner that cannot reliably be performed by a human or even a plurality of humans, e.g., interpreting and rapidly utilizing alerts, events, and messages between systems that may encoded communications between program modules of systems.

Aspects of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

Software and system maintenance is the process of keeping infrastructure and software secured and up to date for smooth and efficient running. Software maintenance is an integral part of software development life cycle (SDLC) and there is a constant demand to keep software, hardware, and firmware up to date to meet ever increasing demands.

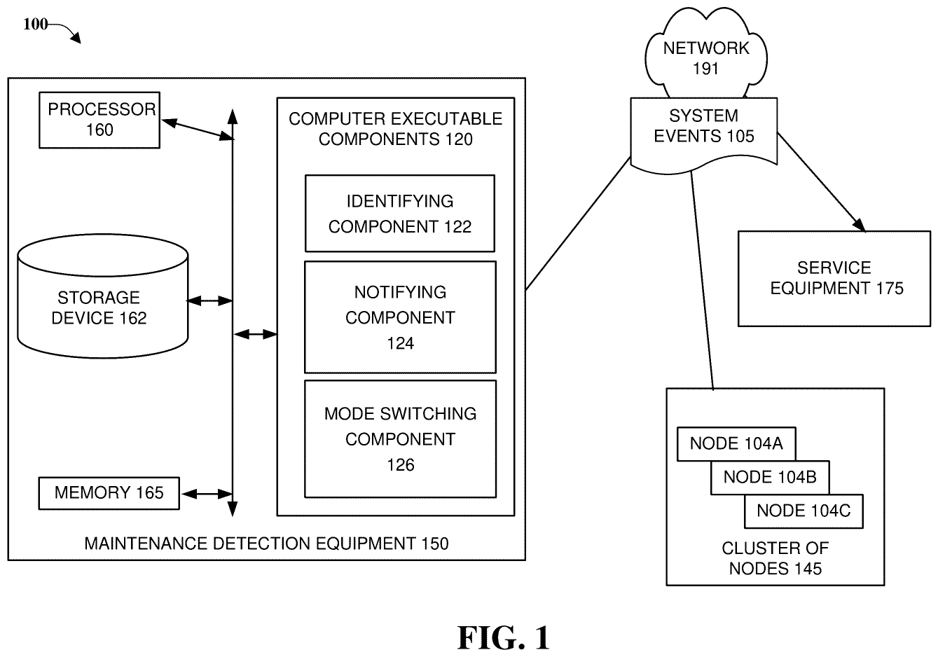

FIG. 1 is an architecture diagram of an example system 100 that can facilitate managing system services based on node maintenance events, in accordance with one or more embodiments. For purposes of brevity, description of like elements and/or processes employed in other embodiments is omitted. As depicted, system 100 includes maintenance detection equipment 150 connected, via network 191, to service equipment 175. System events 105 are received by maintenance detection equipment 150, service equipment 175, and cluster of nodes 145.

As depicted, maintenance detection equipment 150 can include memory 165 that can store one or more computer and/or machine readable, writable, and/or executable components 120 and/or instructions. In embodiments, maintenance detection equipment 150 can further include processor 160. In one or more embodiments, computer executable components 120, when executed by processor 160, can facilitate performance of operations defined by the executable component(s) and/or instruction(s). Computer executable components 120 can include identifying component 122, notifying component 124, mode switching component 126, and other components described or suggested by different embodiments described herein, that can improve the operation of system 100. Maintenance detection equipment 150 may further include storage device 162. In an example, storage device 162 may provide nonvolatile storage of data, data structures, computer executable instructions, and so forth.

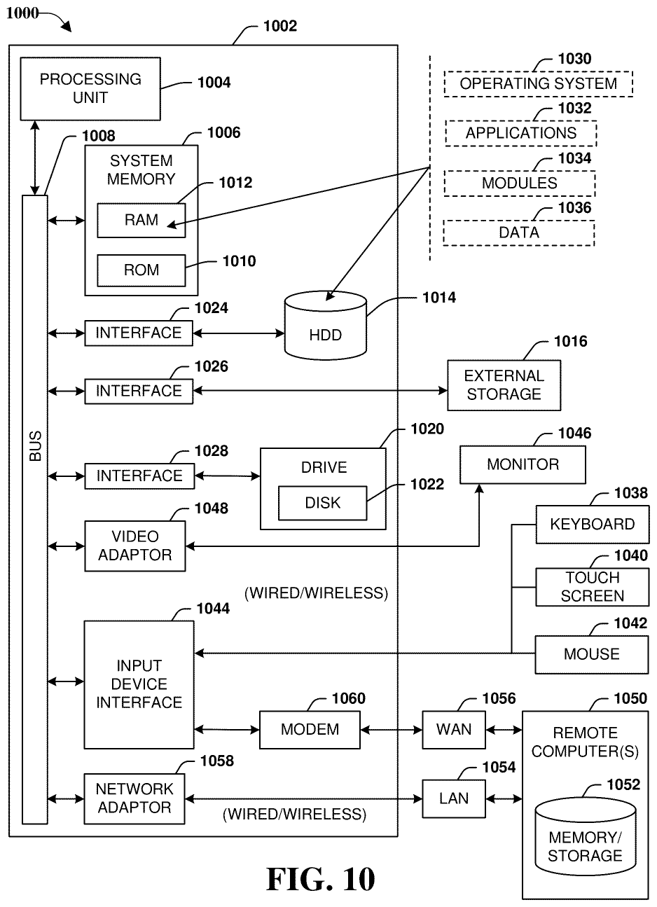

According to multiple embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to, logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a System on a Chip (SOC), an array processor, a vector processor, and other types of processors. Further examples of processor 160 are described below with reference to processing unit 1004 of FIG. 10. Such examples of processor 160 can be employed to implement any embodiments of the subject disclosure.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1006 and FIG. 10. Such examples of memory 165 can be employed to implement any embodiments of the subject disclosure.

In one or more embodiments, computer executable components 120 can be used in connection with implementing one or more of the systems, devices, components, and/or computer-implemented operations shown and described in connection with FIG. 1 or other figures disclosed herein. In an example, memory 165 can store executable instructions that can facilitate generation of identifying component 122, which in some implementations can identify a maintenance event that implicates a node of a cluster of nodes. For example, in one or more embodiments, identifying component 122 may identify a maintenance event of system events 105 that implicates node 104A of cluster of nodes 145.

In another example, memory 165 can store executable instructions that can facilitate generation of notifying component 124, which in some implementations may notify a service that the node is to be in a maintenance mode based on the maintenance event, with the node being at least partially not operative in the maintenance mode, and with the service subscribing to the maintenance event. For example, in one or more embodiments, notifying component 124 can notify a service hosted by service equipment 175 that node 104A is to be in a maintenance mode based on the maintenance event, with node 104A being at least partially not operative in the maintenance mode, and with the service subscribing to the maintenance event.

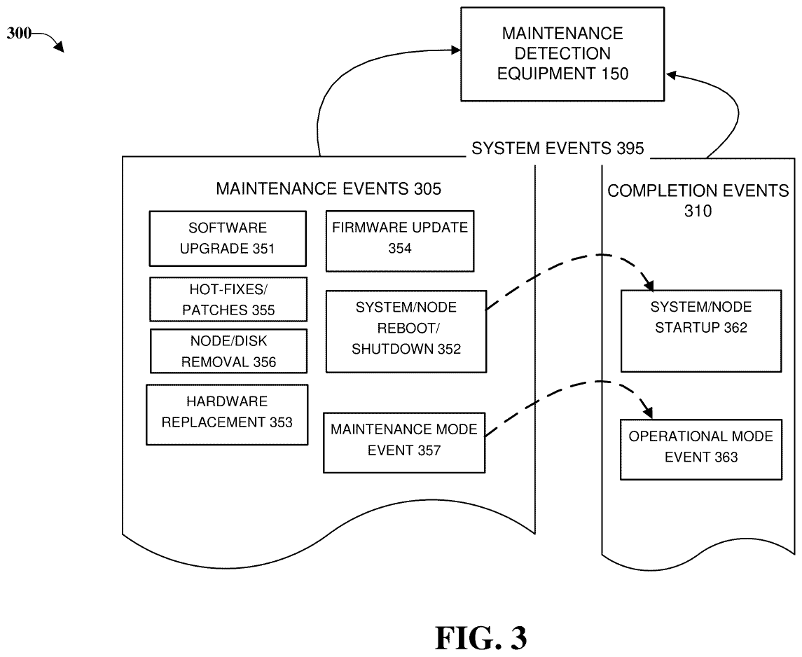

In another example, memory 165 can store executable instructions that can facilitate generation of mode switching component 126, which in some implementations may, based on a completion event that implicates the node with respect to the maintenance event, switch the node from the maintenance mode to an operational mode in which the node is operative. For example, in one or more embodiments, mode switching component 126 may, based on a completion event of system events 105 that implicates node 104A with respect to the maintenance event, switch the node from the maintenance mode to an operational mode in which the node is operative. Maintenance events and completion events are discussed with FIG. 3 and generally include system events which, respectively, may indicate to maintenance detection equipment 150 that maintenance will be commencing, is commencing, or has commenced at a particular node, and events which indicate that maintenance has been completed.

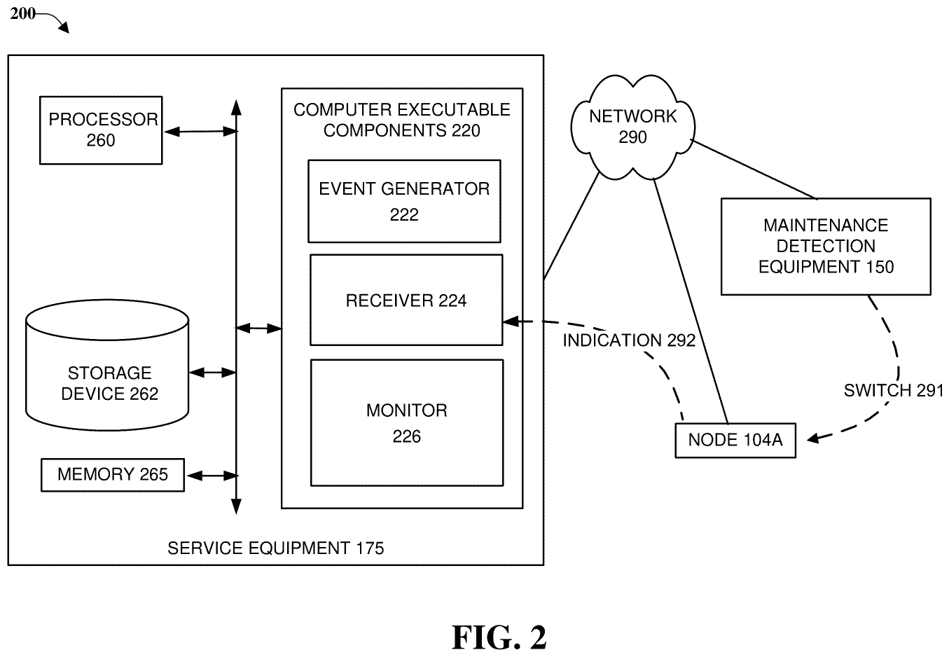

It should be noted that maintenance detection equipment 150, service equipment 175, and other devices discussed herein, can execute code instructions that may operate on servers or systems, remote data centers, or ‘on-box’ in individual client information handling systems, according to various embodiments described herein. In some embodiments, it is understood any or all implementations of one or more embodiments described herein can operate on a plurality of computers, collectively referred to as maintenance detection equipment 150. For example, one or more of the functions of maintenance detection equipment 150, and service equipment 175, can all be implemented as separate subsystems running in the kernel of a computing device as well as operating on separate network equipment, e.g., as depicted in FIGS. 1 and 2.

FIG. 2 is an architecture diagram of an example system 200 that can facilitate managing system services based on node maintenance events, in accordance with one or more embodiments. For purposes of brevity, description of like elements and/or processes employed in other embodiments is omitted. As depicted, system 200 includes service equipment 175 connected, via network 290, to maintenance detection equipment 150. Service equipment 175 includes processor 260, memory 265, storage device 262, and computer executable components 220.

In embodiments, processor 260 is similar to processor 160 and storage device 262 is similar to storage device 162, discussed above. According to multiple embodiments, memory 265 can store one or more computer and/or machine readable, writable, and/or executable components 220 and/or instructions. In one or more embodiments, computer executable components 220, when executed by processor 260, can facilitate performance of operations defined by the executable component(s) and/or instruction(s). Computer executable components 220 can include event generator 222, receiver 224, monitor 226, and other components described or suggested by different embodiments described herein, e.g., that can improve the operation of system 200, in accordance with one or more embodiments.

As discussed further with FIG. 10 below, network 290 can employ various wired and wireless networking technologies. For example, embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), fifth generation core (5G Core), fifth generation option 3x (5G Option 3x), high speed packet access (HSPA), Z-Wave, Zigbee and other 802.XX wireless technologies and/or legacy telecommunication technologies.

In an example implementation of service equipment 175, memory 265 can store executable instructions that can facilitate generation of event generator 222, which in some implementations, may generate a system event that corresponds to a node of a cluster of nodes. For example, one or more embodiments, event generator 222 may generate maintenance event of system events 105 that correspond to node 104A of cluster of nodes 145.

In an example implementation of service equipment 175, memory 265 can further store executable instructions that can facilitate generation of receiver 224, which in some implementations, may receive a first indication from a first monitor that the node has switched to a maintenance mode based on the system event. For example, in one or more embodiments, receiver 224 may receive indication 292 from node 104A that the node has switched to a maintenance mode based on the system event. In an example, in response to the determining that the system event comprises the maintenance event, maintenance detection equipment may switch 291 node 104A to a maintenance mode from an operational mode.

In an example implementation of service equipment 175, memory 265 can further store executable instructions that can facilitate generation of monitor 226, which in some implementations, may monitor event information corresponding to a second indication that the node has switched to an operational mode. For example, in one or more embodiments, monitor 226 may monitor event information corresponding to an indication that node 104A has switched back to an operational mode, e.g., after completion of the detected maintenance event.

FIG. 3 includes a diagram of an example system 300 that can facilitate managing system services based on detection of node maintenance and completion events, in accordance with one or more embodiments. For purposes of brevity, description of like elements and/or processes employed in other embodiments is omitted. System 300 includes maintenance detection equipment 150 detecting system events 395 that include maintenance events 305 and detecting completion events 310.

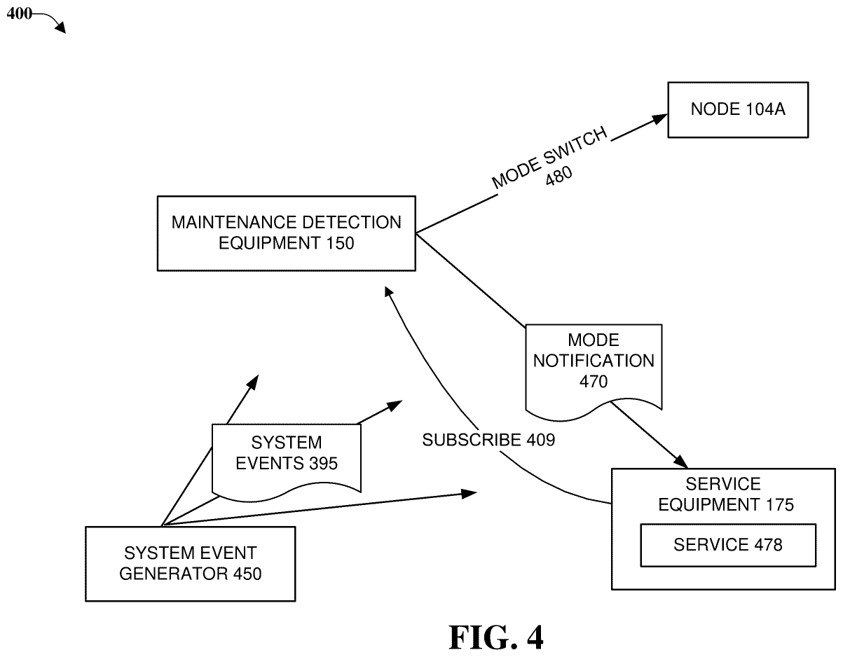

One or more embodiments of maintenance detection equipment 150 can automatically manage the life cycle of maintenance across clusters of nodes by detecting the time periods of maintenance for combinations of nodes, e.g., by detecting the beginning (or scheduling) of the maintenance via detection of maintenance events 305. In system 300, maintenance events 305 include software upgrade 351, system/node reboot/shutdown 352, hardware replacement 353, firmware update 354, hot-fixes/patches 355, and node/disk removal 356. Maintenance events 305 may also broadly include an indication that a node will enter/has entered/in currently in a maintenance mode (discussed with FIG. 4 below).

It is understood that these examples are non-limiting, and other similar events may also be used by one or more embodiments to detect periods of maintenance. Maintenance events 305 are selected for embodiments as being common entry points for life cycle management (LCM), e.g., simultaneous upgrades, node removal etc. In addition, events may be related to upgrade of hardware or could be associated with upgrade of software within virtual machine.

Stated differently, one or more embodiments may detect and track a maintenance entry point (e.g., maintenance events 305) for a node, and enable a service that depends upon the node for operation to prepare and conduct activities that take the maintenance of the node into account. As discussed with FIG. 4 below, in one or more embodiments, services dependent upon one or more nodes may subscribe to nodes that are used for operation of the services. Thus, once maintenance activity is detected, maintenance detection equipment 150 may enable subscribed services to prepare for the maintenance period. Detected maintenance events 305 may be automatic (e.g., scheduled or triggered) or manually initiated events.

An example maintenance event 305 can be a broad, system-wide upgrade of an operating system where all nodes would go through the upgrade process, e.g., software upgrade 351, e.g., with network pooling, and/or load balancing among nodes. Maintenance events can also have a more limited scope, e.g., firmware upgrade 354 of a subset of nodes. Maintenance periods may be detected by major events such as system/node reboot/shutdown 352, while some maintenance periods do not require a reboot. Events such as a reboot, one or more embodiments may set a maintenance window pre-emptively, with enough time to reschedule service dependencies. Maintenance periods may also be estimated/detected by the detection of completion events 310, e.g., system/node startup 362, and operational mode event 363.

It is noted that, while some examples herein discuss system events regarding maintenance of a node (e.g., node 104A), these examples are not limiting, and events may be tracked for combinations of one or more nodes, e.g., cluster of nodes 145. For example, maintenance events 305 may be detected and tracked as being relevant to multiple nodes of the cluster of nodes 145, and completion events 310 may be similarly handled, e.g., nodes 104A-C may be subject to maintenance, and completion 310 events may be detected for nodes 104A-C.

FIG. 4 includes a diagram of an example system 400 that can facilitate managing system services based on detection of node maintenance events, in accordance with one or more embodiments. For purposes of brevity, description of like elements and/or processes employed in other embodiments is omitted. System 400 includes maintenance detection equipment 150, node 104A, system event generator 450, service and equipment 175. System event generator generates system events 395 detected by maintenance detection equipment 150, node 104A, and service equipment 175. Maintenance detection equipment 150 sends mode notification 470 to service equipment 175, and sends mode switch 480 signal to node 104A.

In one or more embodiments, node 140A may be scheduled for a maintenance operation. Service 478 of service equipment 175 depends upon node 104A for operation of aspects of the service. Based on this dependence, one or more embodiments enables service equipment 175 to subscribe to certain types of system events 395 associated with node 104A. Different implementations may facilitate this description in different ways, e.g., service equipment 175 requesting a subscription from maintenance detection equipment 150, e.g., subscribe 409. Based on different requirements of service 478, service equipment 175 may subscribe to system events 395 that would render node 104A unavailable to service 478.

Continuing this example, as preparation for the maintenance event for node 104A proceeds, a system event 395 may be generated that indicates that maintenance of node 104A is upcoming, e.g., a scheduled node/disk removal 356 for node 104A. As discussed herein, events have varying information about the scheduling of events. In this example, a time for the node/disk removal 356 is indicated in the system event. Other types of system events 395, e.g., an event indicating a node shutdown 532 has commenced, may only have a time the event commenced included.

For convenience of description, FIG. 4 includes system event generator 450 to represent different sources in the network system that generate events. In this example, the scheduled node/disk removal 356 may have been generated by a maintenance configuration server, while a node shutdown event may be generated by node 104A as the event occurs.

Continuing this example, system event 395 is generated and received by maintenance detection equipment 150. Based on the subscription of service 478 to maintenance events that implicate node 104A, maintenance detection equipment 150 identifies system event 395 for additional processing. In an implementation, based on the identified maintenance event, maintenance detection equipment 150 may communicate a mode notification 470 to service equipment 175, e.g., indicating that node 104A has a scheduled maintenance mode (e.g., for node/disk removal 356 scheduled) and/or that a maintenance event has commenced (e.g., a reboot 352 occurring).

During the maintenance of node 104A, maintenance detection equipment 150 may monitor system events 395 for additional events that implicate the maintenance. In one or more embodiments, during maintenance of node 104A, maintenance detection equipment 150 further may continue to provide details to subscribers to particular events. In an implementation, depending on the event, a field replaceable unit may be automatically provided to replace some of the functions provided by node 104A.

In an example of event detection by maintenance detection equipment 150 during maintenance, a system startup 362 event for node 104A may be detected by maintenance detection equipment 150, and this event may be identified as being indicative of the end of the maintenance of node 104A, e.g., completion event 310. In an embodiment, based on the identified completion event implicating node 104A, maintenance detection equipment 150 may provide mode notification 470 to service equipment 175 that node 104A has switched from a maintenance mode to an operational node.

Based at least on these operations, one or more embodiments can detect maintenance events at the node level and propagate the events to the system/solution level. Similarly, when maintenance of a node ends, one or more embodiments exit the maintenance mode and return the node to normal/operational mode. In implementations. It is noted that, in some embodiments, the end of the maintenance mode for node 104A does not end at a preset or estimated time, rather, maintenance detection equipment 150 detects the end of the maintenance period based on analysis of one or more system events 395. In some implementations, this automatic determination of a maintenance window for node 104A may prevent node 104A from inefficiently being left inactive for a period longer than is required to complete the maintenance.

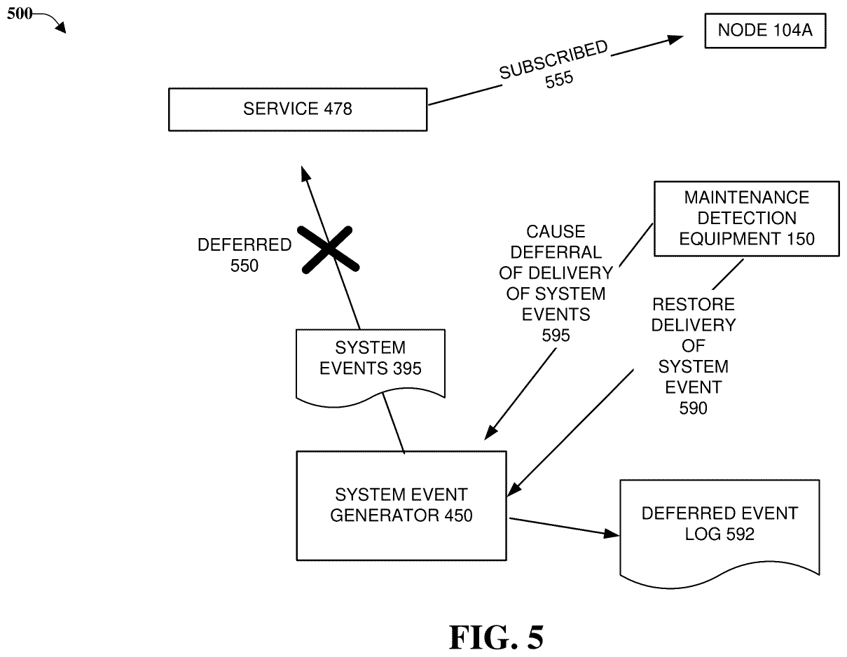

FIG. 5 includes a diagram of an example system 500 that can facilitate managing system services based on detection of node maintenance events that may be specific to micro-clusters of activity, in accordance with one or more embodiments. For purposes of brevity, description of like elements and/or processes employed in other embodiments is omitted. System 500 includes maintenance detection equipment 150 service equipment 175, and system event generator 450. System event generator 450 sends system events 395 to service equipment 175 and maintenance detection equipment 150 either restores delivery of system events 590 or defers system event delivery 595.

In the example depicted in FIG. 5, node 104A has entered a maintenance mode for a period of maintenance. Service 478 is subscribed 555 to maintenance events of node 104A and thus is notified at a time (in advance or at the time maintenance begins) that node 104A is in maintenance mode. During the maintenance of node 104A, system event generator 450 continues to propagate system events associated with node 104A.

In one or more embodiments, during a maintenance mode for node 104A, maintenance detection equipment 150 may cause 595 delivery to service 478, of system events 395 associated with node 104A, to be deferred 550 until a later time, e.g., until after the maintenance has been completed. This deferral may be enabled by maintenance detection equipment 150 providing instructions for system event generator 450, by providing instructions to service equipment 175 to not process system events 395, or by other approaches having similar results. Instructions to systems causing the deferral (also termed delay herein) of the delivery of system events 395 may also direct that these events by logged in a deferred event log 592.

Upon exit of the maintenance mode, the delivery of system events 395 to service 478 may be restored 590, and the system events 395 for which delivery/processing by service 478 was deferred may be delivered to/processed by service 478, e.g., based on deferred event log 592. This deferred event log 592 may also be used for auditing and analysis of system operation.

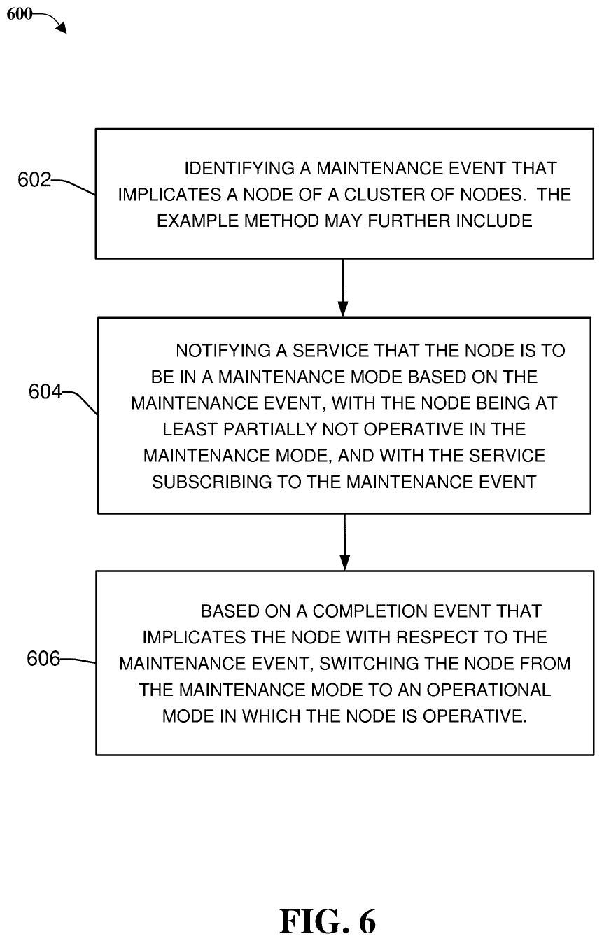

FIG. 6 depicts a flow diagram representing example operations of an example method 600 that can facilitate managing system services based on detection of node maintenance events, in accordance with one or more embodiments. For purposes of brevity, description of like elements and/or processes employed in other embodiments is omitted.

In some examples, one or more embodiments of method 600 can be implemented by identifying component 122, notifying component 124, mode switching component 126, and other components that can be used to implement aspects of method 600, in accordance with one or more embodiments. FIG. 6, described below illustrates methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

At 602 of method 600, identifying component 122 of maintenance detection equipment 150 can identify a maintenance event that implicates a node of a cluster of nodes. At 604 of method 600, notifying component 124 can notify a service that the node is to be in a maintenance mode based on the maintenance event, with the node being at least partially not operative in the maintenance mode, and with the service subscribing to the maintenance event. At 606 of method 600, mode switching component 126 can, based on a completion event that implicates the node with respect to the maintenance event, switch the node from the maintenance mode to an operational mode in which the node is operative.

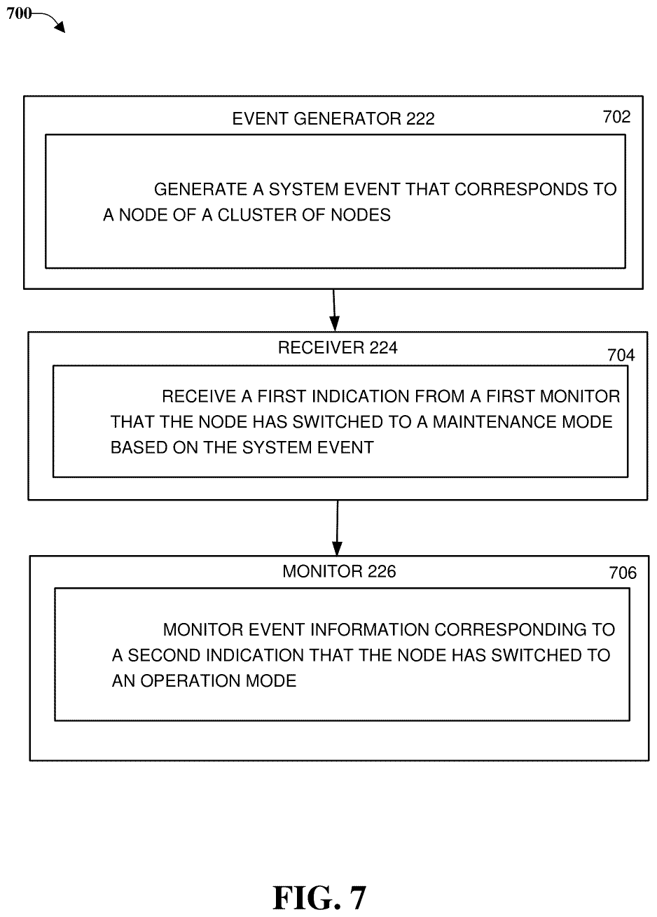

FIG. 7 depicts an example system 700 that can facilitate managing system services based on node maintenance events, in accordance with one or more embodiments. For purposes of brevity, description of like elements and/or processes employed in other embodiments is omitted.

System 700 includes at least one memory that stores computer executable components, and at least one processor that executes the computer executable components stored in the at least one memory, with the computer executable components including event generator 222, receiver 224, monitor 226, and other components that can be used to implement aspects of system 700, as described herein, in accordance with one or more embodiments.

At 702 of FIG. 7, event generator 222 can generate a system event that corresponds to a node of a cluster of nodes. At 704 of FIG. 7, receiver 224 can receive a first indication from a first monitor that the node has switched to a maintenance mode based on the system event. At 706 of FIG. 7, monitor 226 can monitor event information corresponding to a second indication that the node has switched to an operational mode.

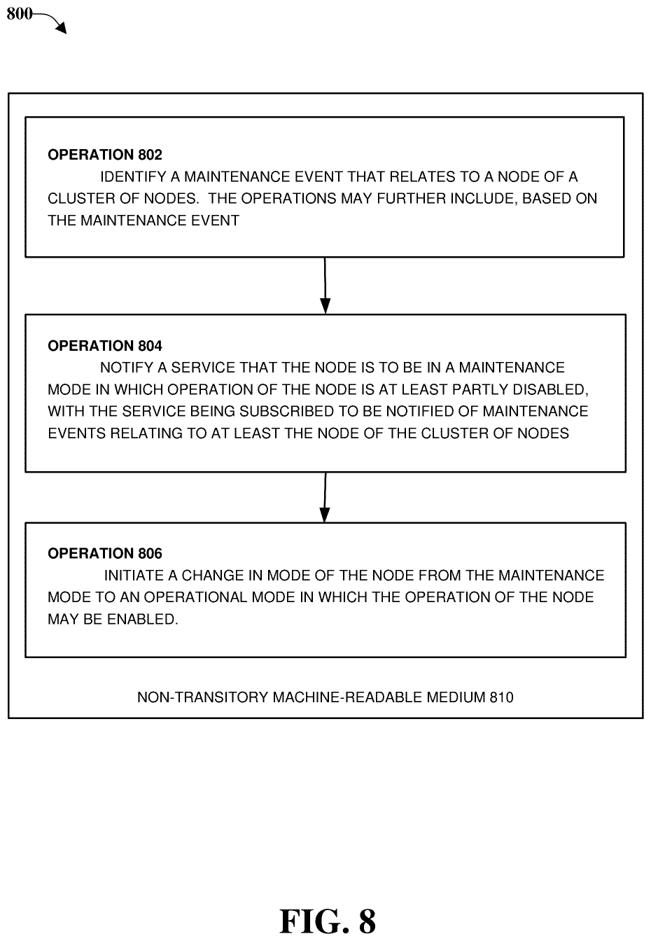

FIG. 8 depicts an example 800 non-transitory machine-readable medium 810 that can include executable instructions that, when executed by a processor of a system, can facilitate managing system services based on node maintenance events, in accordance with one or more embodiments. For purposes of brevity, description of like elements and/or processes employed in other embodiments is omitted.

As depicted, non-transitory machine-readable medium 810 includes executable instructions that, when executed by at least one processor of a machine learning device, facilitate performance of operations that include operation 802 which can identify a maintenance event that relates to a node of a cluster of nodes. The operations may further include operation 804 which can, based on the maintenance event, notify a service that the node is to be in a maintenance mode in which operation of the node is at least partly disabled, with the service being subscribed to be notified of maintenance events relating to at least the node of the cluster of nodes. The operations may further include operation 806 which can, based on a completion event that relates to the node, initiate a change in mode of the node from the maintenance mode to an operational mode in which the operation of the node may be enabled.

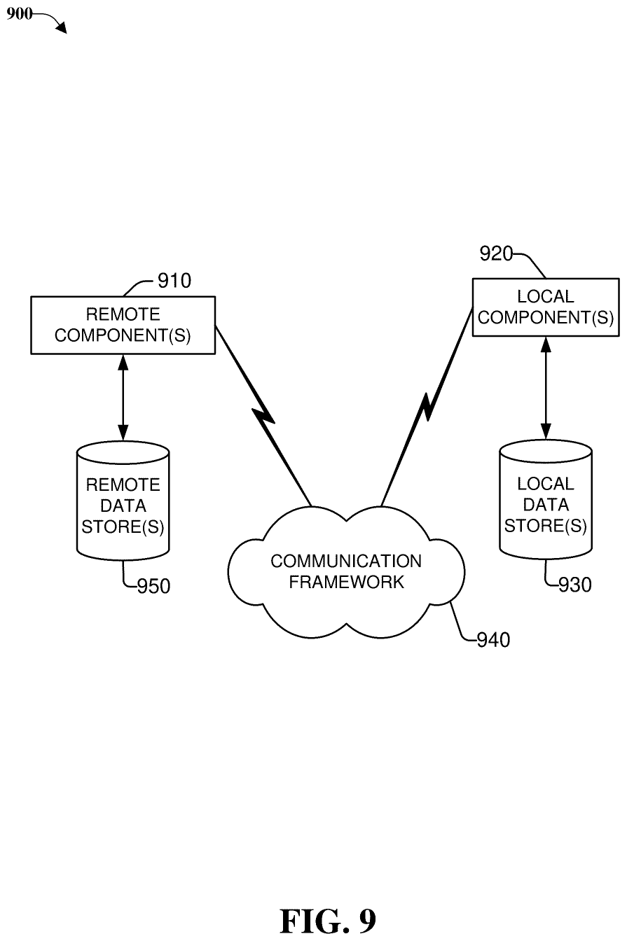

FIG. 9 is a schematic block diagram of a system 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, RAN devices, gateway devices, femtocell devices, servers, etc. The system 900 also comprises one or more local component(s) 920. The local component(s) 920 can be hardware and/or software (e.g., threads, processes, computing devices).

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

In order to provide a context for the various aspects of the disclosed subject matter, the following discussion is intended to provide a brief, general description of a suitable environment in which the various aspects of the disclosed subject matter can be implemented. While the subject matter has been described above in the general context of computer executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or non-volatile memory, or can comprise both volatile and non-volatile memory, for example, by way of illustration, and not limitation, volatile memory 1020 (see below), non-volatile memory 1022 (see below), disk storage 1024 (see below), and memory storage, e.g., local data store(s) 930 and remote data store(s) 950, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in different systems, e.g., both local and remote memory storage devices.

Referring now to FIG. 10, in order to provide additional context for various embodiments described herein, FIG. 10 and the following discussion are intended to provide a brief, general description of a suitable computing environment 1000 in which the various embodiments described herein can be implemented.

While the embodiments have been described above in the general context of computer executable instructions that can run on one or more computers, those skilled in the art will recognize that the embodiments can be also implemented in combination with other program modules and/or as a combination of hardware and software. For purposes of brevity, description of like elements and/or processes employed in other embodiments is omitted.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application program interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “network device,” “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

Additionally, the terms “core-network,” “core,” “core carrier network,” “carrier-side,” or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment does not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2 ) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) RAN or GERAN; UMTS Terrestrial Radio Access Network (UTRAN); or LTE Advanced.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
identifying, by a system comprising at least one processor, a maintenance event that implicates a node of a cluster of nodes;
notifying, by the system, a service that the node is to be in a maintenance mode based on the maintenance event, wherein the node is at least partially not operative in the maintenance mode, and wherein the service subscribes to the maintenance event; and
based on a completion event that implicates the node with respect to the maintenance event, switching, by the system, the node from the maintenance mode to an operational mode in which the node is operative.

2. The method of claim 1, further comprising, notifying, by the system, the service that the node is in the operational mode.

3. The method of claim 1, wherein the maintenance event comprises an event indicating that the node is to be in the maintenance mode.

4. The method of claim 1, wherein the maintenance event comprises an event indicating that the node has already entered the maintenance mode.

5. The method of claim 1, wherein the completion event is identified based on the maintenance event and the node.

6. The method of claim 1, wherein the method further comprises, during the maintenance mode, delaying, by the system, delivery of a system alert to the service until the operational mode of the node is restored.

7. The method of claim 1, further comprising:
monitoring, by the system, system events generated by operation of the cluster of nodes;
analyzing, by the system, the system events;
based on the analyzing, determining, by the system, that a system event of the system events comprises a maintenance event; and
in response to the determining that the system event comprises the maintenance event, switching, by the system, the node to the maintenance mode from the operational mode.

8. The method of claim 7, wherein the system event comprises at least one of a reboot event, a shutdown event, a node removal event, an upgrade event, or a hardware replacement event.

9. The method of claim 1, further comprising:
during the maintenance mode, monitoring, by the system, system events generated by operation of the cluster of nodes;
analyzing, by the system, the system events; and
based on the analyzing, determining, by the system, that a system event of the system events comprises a completion event that implicates completion of the maintenance event,
wherein the switching of the node to the operational mode switching the node to the operational mode in response to the determining that the system event comprises the completion event that implicates completion of the maintenance event.

10. The method of claim 1, wherein the completion event comprises a reversal of the maintenance event.

11. The method of claim 9, wherein the completion event comprises a startup event.

12. A device, comprising:
at least one memory that stores computer executable components; and
at least one processor that executes the computer executable components stored in the at least one memory, wherein the computer executable components comprise:
an event generator that generates a system event that corresponds to a node of a cluster of nodes,
a receiver that receives a first indication from a first monitor that the node has switched to a maintenance mode based on the system event, and
a second monitor that monitors event information corresponding to a second indication that the node has switched to an operational mode.

13. The device of claim 12, wherein the computer executable components further comprise, a service provider that provides a service to the cluster, and wherein the receiver receives the first indication from the service provider based on the service being subscribed to communicate notifications from the first monitor.

14. The device of claim 13, wherein, based on the service being subscribed to communicate the notifications, the second monitor monitors the second indication that the node has switched to the operational mode.

15. The device of claim 13, wherein the service provider further generates a message for the node based on the service, and, based on the node being in the maintenance mode, delays communication of the message to the node.

16. The device of claim 15, wherein the service provider further provides the message to the node based on the second indication.

17. A non-transitory machine-readable medium comprising executable instructions that, when executed by at least one processor, facilitate performance of operations, the operations comprising:
identifying a maintenance event that relates to a node of a cluster of nodes;
based on the maintenance event, notifying a service that the node is to be in a maintenance mode in which operation of the node is at least partly disabled, wherein the service has subscribed to be notified of maintenance events relating to at least the node of the cluster of nodes, and wherein; and
based on a completion event that relates to the node, initiating a change in mode of the node from the maintenance mode to an operational mode in which the operation of the node is enabled.

18. The non-transitory machine-readable medium of claim 17, wherein the operations further comprise, based on the maintenance mode:
suppressing delivery of alert messages from the service directed to the node, resulting in suppressed messages; and
logging the suppressed messages.

19. The non-transitory machine-readable medium of claim 18, wherein the operations further comprise, based on the operational mode, enabling delivery of the suppressed messages to the node.

20. The non-transitory machine-readable medium of claim 17, wherein the service comprises a cluster-wide event log.
